(19) United States
(12) Patent Application Publication
(10) Pub. No.: US 2005/0104529 A1
(43) Pub. Date: May 19, 2005

(54) Power supply and light emitting display device using the same

(76) Inventors: Sung-Chon Park, Suwon-si (KR); Choon-Yui Oh, Suwon-si (KR)

Correspondence Address: MCGUIREWOODS, LLP, 1750 TYSONS BLVD, SUITE 1800, MCLEAN, VA, 22102, US

(21) Appl. No.: 10/976,806

(22) Filed: Nov. 1, 2004

(30) Foreign Application Priority Data
Nov. 14, 2003 (KR) 10-2003-0080546

(51) Int. Cl. G09G 3/10

(52) U.S. Cl. 315/169.3

(57) ABSTRACT

A power supply and a light emitting display device using the same and having an improved efficiency, are disclosed. The light emitting display device includes a driving transistor and a light emitting element for emitting light according to an operation of the driving transistor. A first voltage supplied to the driving transistor and a second voltage supplied to the light emitting element are established so that an absolute value of the first power supply voltage is greater than or equal to an absolute value of the second power supply voltage.

### CROSS REFERENCE TO RELATED APPLICATION

This application claims priority to of Korean Patent Application No. 2003-80546 filed on Nov. 14, 2003 in the Korean Intellectual Property Office, which is herein incorporated by reference.

### BACKGROUND OF THE INVENTION

1. Field of the Invention

The present invention generally relates to a power supply, and more particularly, to a light emitting display device using the same.

2. Description of the Related Art

In general, an organic EL display electrically excites a phosphorous organic compound to emit light, and it voltage-drives or current-drives a matrix of N×M organic is emitting cells to display images. The organic emitting cell comprises an anode (ITO), an organic thin film, and a cathode layer (metal). The organic thin film has a multi-layered structure that includes an EML (emitting layer), an ETL (electron transport layer), and an HTL (hole transport layer) for maintaining balance between electrons and holes and improving emitting efficiencies. The multi-layered structure further comprises an EIL (electron injecting layer) and an HIL (hole injecting layer).

Methods for driving the organic emitting cells include a passive matrix method, and an active matrix method which uses TFTs (thin film transistors) or MOSFETs. The passive matrix method forms cathodes and anodes to cross with each other, and selectively drives lines. The active matrix method couples a TFT to each ITO (indium tin oxide) pixel electrode to thereby maintain a voltage by capacitance of a capacitor coupled to a gate of the TFT. The active matrix method is classified as either a voltage programming method or a current programming method, depending on the type of signal forms supplied to store a voltage in a capacitor.

In either the voltage driving method or the current driving method, an organic light emitting cell generally includes an organic EL element (OLED) that includes a driving transistor coupled to the organic EL element to drive the organic EL element. In operation, a first power supply voltage is supplied to a drain of the driving transistor, and a second power supply voltage is delivered to one terminal of the organic EL element OLED. Thereafter, the organic EL element OLED emits light according to an operation of the driving transistor.

In general, the first power supply voltage is a voltage of VDD which is supplied to an anode electrode of the organic EL element OLED, and the second power supply voltage of Vss is supplied to a cathode electrode of the organic EL element OLED. At times, a ground voltage is supplied to the cathode, while a voltage less than the first power supply voltage is supplied to the anode. Thus it is sometimes difficult to apply an appropriate lighting voltage because the light emitting efficiency of the organic EL element OLED differs based on differences between the first power supply voltage and the second power supply voltage.

Consequently, a need exists for an OLED power supply that supplies lighting voltages in a manner that improves the light-emitting efficiency of the OLED's organic light-emitting element.

### SUMMARY OF THE INVENTION

The present invention provides a power supply for supplying lighting voltages that improve a light emitting efficiency of a light emitting element. Additionally the present invention provides a power supply having an improved driving efficiency.

In one embodiment of the present invention, a power supply for supplying a first voltage and a second voltage for a lighting process to corresponding first and second terminals of a light emitting display device, includes a voltage input unit for receiving an external voltage. The power supply also includes a first voltage generator for generating the first voltage based on an input voltage, and a second voltage generator for generating the second voltage based on the input voltage. In one embodiment, the absolute value of the first voltage is greater than or equal to the absolute value of the second voltage.

The second voltage is an inverted voltage of the first power supply voltage, the first voltage is a positive voltage and the second voltage is a negative voltage, and the power supply is a step-up DC/DC converter.

In another aspect of the present invention, a light emitting display device includes a plurality of data lines for transmitting data signals and a plurality of signal lines crossing the data lines for transmitting scan signals. The OLED also includes a plurality of pixel circuits, each having a light emitting element for displaying images corresponding to the transmitted data signals, the pixel circuits being respectively formed at areas formed by crossing the data lines and the signal lines The OLED further includes, a power supply for supplying a first voltage and a second voltage to both ends of each light emitting element of each pixel circuit, such that an absolute value of the first power supply voltage is greater than or equal to the absolute value of the second power supply voltage.

In an embodiment, the pixel circuit includes a driving transistor having a source terminal to which a first voltage is applied. The pixel circuit further includes a light emitting element having a first terminal coupled to a drain terminal of the driving transistor and a second terminal to which the second voltage is applied.

### BRIEF DESCRIPTION OF THE DRAWINGS

FIG. 1 is a plan view of a light emitting display device according to one embodiment of the present invention.

FIG. 2 is a brief circuit diagram of a pixel circuit of a light emitting display device according to one embodiment of the present invention.

FIG. 3 is a diagram of illustrating the coupled states of a power supply and a pixel circuit shown in FIG. 1.

FIG. 4 is a block diagram of a brief configuration of a power supply according to one embodiment of the present invention.

FIG. 5 shows voltage characteristics of a power supply according to one embodiment of the present invention.

FIG. 6 is a graph for illustrating driving efficiency of a voltage driver compared to the voltage characteristics shown in FIG. 5.

FIG. 7 shows voltage characteristics of a power supply according to one embodiment of the present invention.

FIG. 8 is a graph that illustrates a driving efficiency of a voltage driver having to the voltage characteristics shown in FIG. 7.

### DETAILED DESCRIPTION OF THE PREFERRED EMBODIMENTS

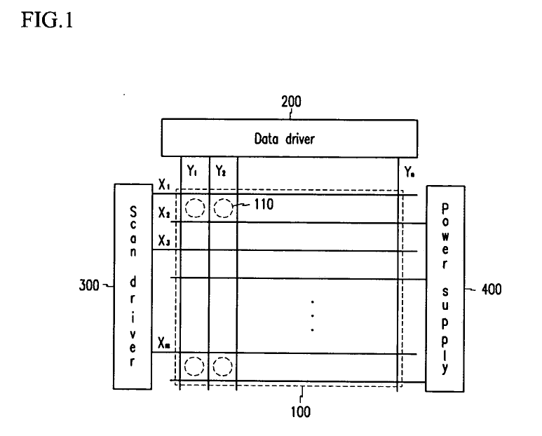

Referring to FIG. 1, the light emitting display device according to one embodiment of the present invention includes an organic EL display panel (hereinafter, referred to as a display panel) 100, a data driver 200, a scan driver 300, and a power supply 400.

The display panel 100 includes a plurality of data lines Y₁ to Yₙ arranged in the vertical direction, a plurality of signal lines X₁ to Xₘ arranged in the horizontal direction, and a plurality of pixel circuits 110 which are formed at pixel areas bounded by the data lines Y₁ to Yₙ and the signal lines X₁ to Xₘ.

The data driver 200 applies a data voltage V_{DATA} to the data lines Y₁ to Yₙ, and the scan driver 300 sequentially applies scan signals for selecting pixel circuits to signal lines X₁ to Xₘ. The power supply 400 supplies a lighting voltage to the respective pixel circuits 110.

The data driver 200, the scan driver 300, and the power supply 400 may be coupled to the display panel 100, and may be provided in a chip format on a TCP (tape carrier package) attached and coupled to the display panel 100. Alternatively, the data driver 200, the scan driver 300, and the power supply 400 may be provided in a chip format on an FPC (flexible printed circuit) or a film attached and coupled to the display panel 100 (this is referred to as a COF (chip on film) method), or may be directly provided on a glass substrate of the display panel (this is referred to as a COG (chip on glass) method). They can also be substituted for a driving circuit formed on the same layer as those of the scan lines, data lines, and TFTs (thin-film transistors) on the glass substrate.

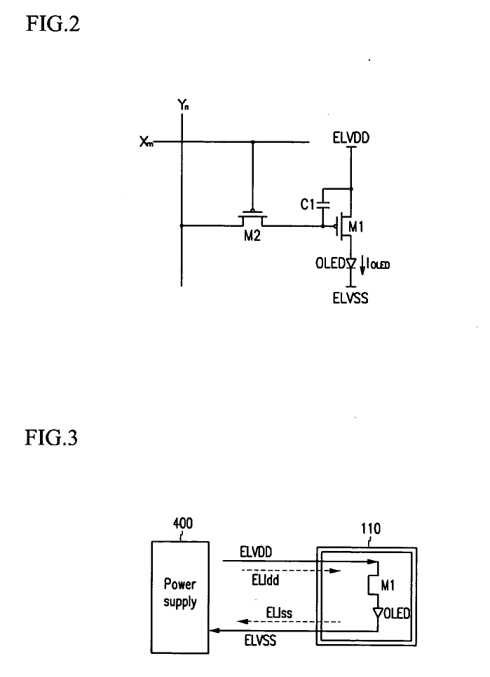

FIG. 2 illustrates a pixel circuit according to one embodiment of the invention. The pixel circuit shown in FIG. 2 is a voltage driving type pixel circuit used to describe the pixel circuit according to one embodiment. However, the invention is not so limited, and may include a current driving type pixel circuit.

As shown in FIG. 2, the pixel circuit includes an organic EL element OLED and a switching transistor M2. Driven by a scan signal applied through a signal line, the switching transistor supplies a data voltage provided by a data line. The pixel circuit farther includes a capacitor C1 for charging the data voltage, and a driving transistor M1. The driving transistor M1 supplies a current, that corresponds to the voltage charged in the capacitor C1, to the organic EL element OLED and this drives the organic EL element of the OLED. In this example a first voltage ELV_{DD} is supplied to a source of the driving transistor M1, and a second power supply voltage ELV_{SS} is supplied to a second terminal of the OLED that has a first terminal coupled to a drain of the driving transistor M1. In this embodiment, power supply 400 provides the first voltage ELV_{DD} and the second voltage ELV_{SS} for lighting the OLED.

As shown in FIG. 3, the power supply 400 includes a DC/DC converter, and generates the first and second voltages, which it supplies to the respective pixel circuits based on the voltage input by a battery (not illustrated).

As to the first and second voltages for emitting the organic EL element OLED, the second voltage should have an appropriate voltage difference from the first voltage so as to maintain the white balance of the display panel. In particular, in order to further improve driving efficiency of the power supply, the first and second voltages should be established so that an is absolute value of the first power supply voltage is greater than or equal to the absolute value of the second power supply voltage. When the absolute value of the first voltage is less than the absolute value of the second voltage, the first voltage should be established so that the absolute value of the first voltage is maximally close to the absolute value of the second voltage, driving efficiency of the power supply 400 improves improves or declines based on the voltage establishment.

For example, consider a case where the first voltage is +5V, and the second voltage is −5V. The 1 V voltage difference therebetween reduces power loss compared to the case in which the first power supply voltage is +5V, the second first power supply voltage is −6V, and the voltage difference therebetween is 11V. Accordingly, the efficiency of the power supply 400 is further improved.

The first power supply voltage may be greater than an input voltage in the power supply 400 having the above-described characteristics. Therefore, a step-up DC/DC converter may be used for the power supply 400. In this instance, the first power voltage should be set to be maximally close to the input voltage because it is more effective to boost the voltage from 3V to 5V than to boost the voltage from 3V to 6V.

As shown in FIG. 4, one embodiment of a power supply 400 includes an input unit 410 for receiving an input voltage, a first voltage generator 420 for boosting the input voltage to generate a first voltage, and a second voltage generator 430 for using the first voltage to generate a second voltage. In this instance, the second voltage generator 430 may be an inverter for inverting the first voltage and outputting an inverted second voltage.

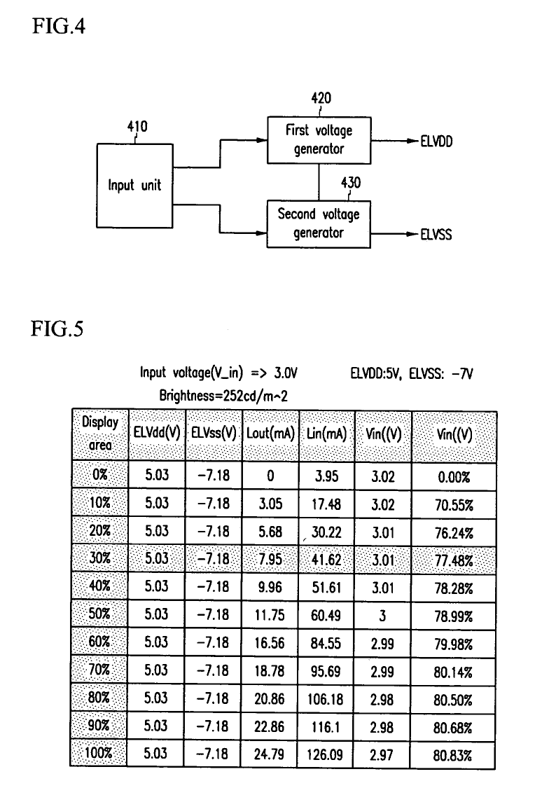

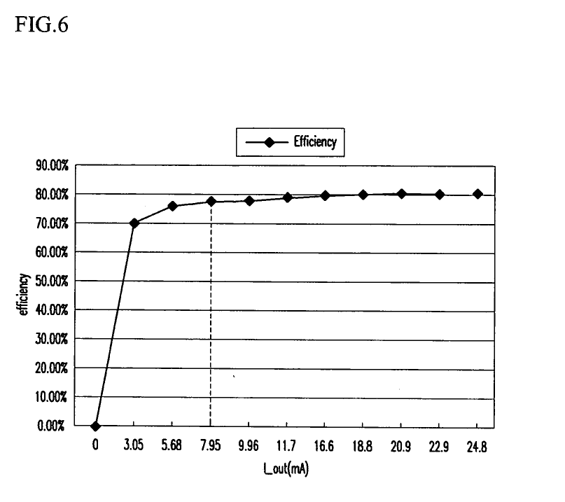

FIG. 5 is a table showing efficiency variations of displayed areas when the input voltage Vᵢₙ is 3V, the first power supply voltage is generated to be close to +5V, and the second power supply voltage is generated to be close to −7V. FIG. 6 is a graph of the efficiency variations shown in FIG. 5.

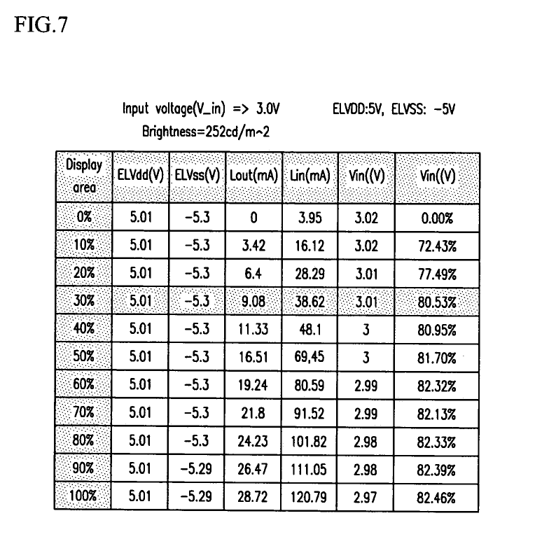

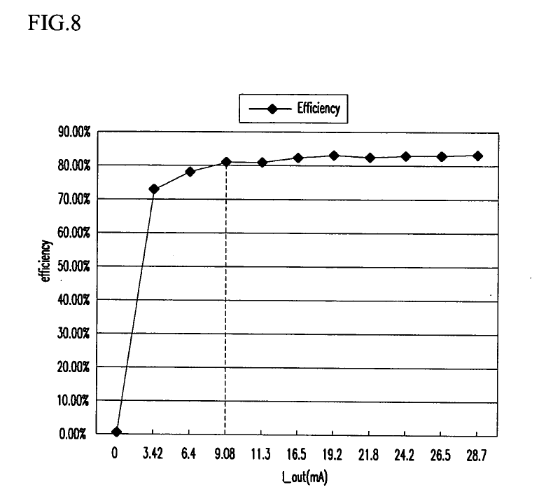

FIG. 7 further illustrates a table of efficiency variations of displayed areas when the input voltage Vin is 3V, the first power supply voltage is generated to be close to +5V, and the second power supply voltage is generated to be close to −5V. FIG. 8 shows a graph of efficiency variations of FIG. 7.

Referring to FIGS. 5, 6, 7, and 8, it is seen that the driving efficiency of the voltage driver is higher in FIG. 7 than in FIG. 5. Thus, small differences between the first and second power supply voltages proportionally reduce the power consumption, and significantly improve voltage generation efficiency of the power supply. In use the first and second voltages respectively generated by the above-characterized power supply are supplied to the pixel circuit shown in FIG. 2. When the switching transistor M2 is turned on by the scan signal received from the signal line, the data voltage provided by the data line flows to the gate of the transistor M1, and the voltage V_{GS} applied between the gate and the source charges the capacitor C1. The current I_{OLED} then flows to the transistor M1 in proportion to the voltage V_{GS}, and the organic EL element OLED emits light in proportion to the current I_{OLED}.

In this example the current flowing to the organic EL element OLED is given below.

$${I}_{OLED} = \frac{β}{2} {( {V}_{GS} - {V}_{TH} )}^{2} = \frac{β}{2} {( {V}_{ELVDD} - {V}_{DATA} - \vert {V}_{TH} \vert )}^{2} \qquad Equation 1$$

where I_{OLED} is a current flowing to the organic EL element OLED, V_{GS} is a voltage applied between the gate and the source of the transistor M1, V_{TH} is a threshold voltage at the transistor M1, V_{DATA} is a data voltage, and β is a constant.

According to an embodiment of the present invention, power consumption is reduced at the time voltages are generated and voltage generation efficiency is improved by generating the first and second power supply voltages so that the difference between the first and second voltages for lighting the light emitting display device is minimized.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A power supply for supplying a first voltage and a second power voltage for a lighting process to corresponding first and second terminals of a light emitting display device, the power supply comprising:
a voltage input unit for receiving an external voltage;
a first voltage generator for generating the first voltage based on the input voltage; and
a second voltage generator for generating the second voltage based on the input voltage,
wherein the absolute value of the first voltage is greater than or equal to the absolute value of the second voltage.

2. The power supply of claim 1, wherein the second voltage is an inverted voltage of the first voltage.

3. The power supply of claim 1, wherein the first voltage is a positive voltage and the second voltage is a negative power supply voltage.

4. The power supply of claim 1, wherein the power supply is a step-up DC/DC converter.

5. A light emitting display device, comprising:
a plurality of data lines for transmitting data signals;
a plurality of signal lines for transmitting scan signals, the signal lines crossing the data lines;
a plurality of pixel circuits including a light emitting element for displaying images corresponding to the transmitted data signals, the pixel circuits being respectively defined by areas bounded by crossed data lines and signal lines; and
a power supply for supplying a first voltage and a second voltage to both ends of each light emitting element of each the plurality of pixel circuits.
wherein an absolute value of the first voltage is greater than or equal to an absolute value of the second voltage.

6. The light emitting display device of claim 5, wherein the light emitting element is an organic EL element.

7. The light emitting display device of claim 5, wherein the second voltage is an inverted voltage of the first voltage.

8. The light emitting display device of claim 5, wherein the pixel circuit comprises:
a driving transistor having a source terminal to which a first voltage is applied; and
a light emitting element having a first terminal coupled to a drain terminal of the driving transistor and a second terminal to which the second voltage is applied.
